(19) United States
(12) Patent Application Publication
(10) Pub. No.: US 2019/0303626 A1
(43) Pub. Date: Oct. 3, 2019

(54) SECURE ENTRY OF SENSITIVE INFORMATION IN GRAPHICAL USER INTERFACES

(71) Applicant: CA, Inc., Islandia, NY (US)

(72) Inventors: Mohammed Mujeeb Kaladgi, Bangalore (IN); Ruqiya Nikhat Kaladgi, Bangalore (IN); Kiran Kumar BS, Bangalore (IN); Mahendra Nimishakavi, Bengaluru (IN)

(73) Assignee: CA, Inc., Islandia, NY (US)

(21) Appl. No.: 15/939,243

(22) Filed: Mar. 28, 2018

(51) Int. Cl. G06F 21/84; G06F 3/0484; G06F 17/24; G06F 8/20

(52) U.S. Cl. CPC G06F 21/84; G06F 3/0484; G06F 2221/031; G06F 8/20; G06F 17/243

(57) ABSTRACT

According to one aspect of the present disclosure, an interactive graphical user interface (GUI) is presented on a display of a personal computing device, and it is determined that the GUI includes an entry field for receipt of sensitive information from a user of the personal computing device. An interaction with the entry field is detected, and at least a portion of the GUI near the entry field is automatically modified to provide a view of physical surroundings near the personal computing device. The portion of the GUI remains modified while the user inputs the sensitive information to the entry field, and the portion of the GUI is modified in response to detecting the interaction and based on determining that the GUI includes a request for entry of sensitive information.

### BACKGROUND

The present disclosure relates in general to the field of information security, and more specifically, to providing secure entry of sensitive information in graphical user interfaces (GUIs).

To gain access to certain information (bank information, health information, or another type of personal information), a user may be prompted by a GUI to enter credentials (e.g., a password) or other sensitive information (e.g., a social security number). When the user is prompted to enter the sensitive information, another person may be “shoulder surfing” (looking at the user's entry in the GUI) or may otherwise have visibility of the user's screen, making entry of the sensitive information insecure. Typically, however, it is difficult for the user to know if there is another person behind the user who is able to see the user's entry of the sensitive information.

### BRIEF SUMMARY

According to one aspect of the present disclosure, an interactive graphical user interface (GUI) may be presented on a display of a personal computing device. It may be determined that the GUI includes an entry field for receipt of sensitive information from a user of the personal computing device. An interaction with the entry field may be detected, and at least a portion of the GUI near the entry field may be automatically modified to provide a view of physical surroundings near the personal computing device. The portion of the GUI may remain modified while the user inputs the sensitive information to the entry field, and the portion of the GUI may be modified in response to detecting the interaction and based on determining that the GUI includes a request for entry of sensitive information.

### BRIEF DESCRIPTION OF THE DRAWINGS

FIG. 1A illustrates an example environment in which the entry of sensitive information on a user device may be secured.

FIG. 1B illustrates a simplified block diagram of the example user device of FIG. 1A.

FIGS. 2A-2B illustrate example GUIs of a user device during entry of information into data entry fields.

FIG. 3 illustrates an example signaling sequence for securing entry of sensitive information on a user device.

FIG. 4 illustrates another example signaling sequence for securing entry of sensitive information on a user device.

FIG. 5 illustrates another example signaling sequence for securing entry of sensitive information on a user device.

FIG. 6 illustrates another example signaling sequence for securing entry of sensitive information on a user device.

FIG. 7 is a flowchart illustrating an example process for securing entry of sensitive information on a user device.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

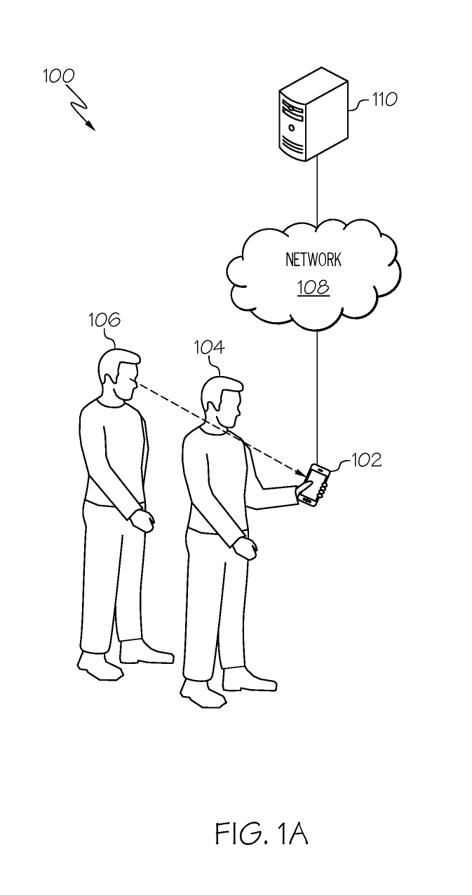

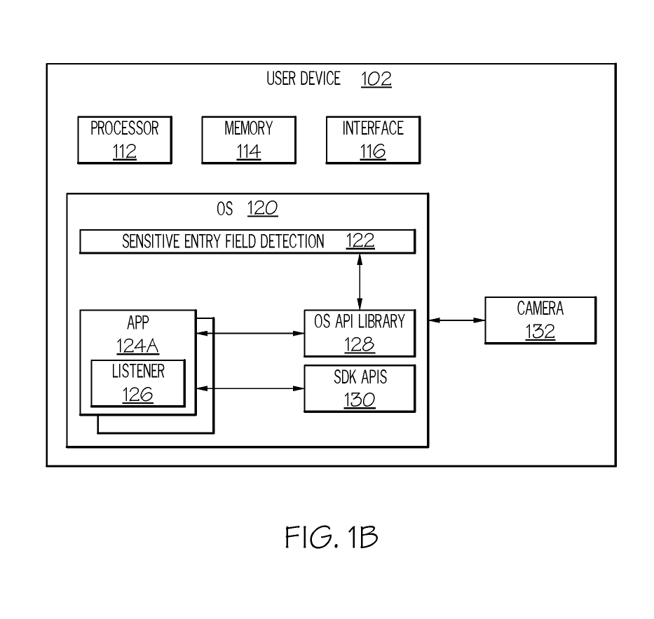

FIG. 1A illustrates an example environment 100 in which the entry of sensitive information on a user device may be secured. In the example shown, a user 104 is interacting with a graphical user interface (GUI) on her user device 102. In some cases, the GUI of the user device 102 may prompt the user 104 to enter sensitive information, such as a password, social security number, or another type of sensitive information. For instance, the GUI may include one or more data entry fields for the sensitive information, and may include additional data entry fields for other types of information (e.g., a username). The GUI may be presented on the user device 102 based on information received from a server 110 (e.g., a web server or other type of server) over the network 108. The network 108 may include one or more networks of different types, including, for example, local area networks, wide area networks, public networks, the Internet, cellular networks, Wi-Fi networks, short-range networks (e.g., Bluetooth or ZigBee), and/or any other wired or wireless communication medium.

For example, the user 104 may be attempting to access bank account information stored on the server 110 (or otherwise accessed by the server 110, e.g., accessed in a database communicably coupled to the server 110) over the network 108. The server 110 may send a request for credentials to the user device 102 over the network 108 before allowing access to the bank information stored thereon, and the user device 102 may present a GUI that includes data entry fields for entry of the requested credentials. However, in the example shown, a person 106 has visibility of the screen (and thus, the GUI) of the user device 102, and the user 104 may be unaware of this. Thus, in certain embodiments, when the user 104 is prompted for sensitive information by a GUI on the user device 102, a portion of the GUI may be automatically modified to provide a view of the physical surrounds near the user device 102, allowing the user 104 to determine whether the person 106 is “shoulder surfing” or viewing the GUI on the user device 102. The view may be provided near the sensitive information entry field, such as, for example, surrounding the sensitive information entry field in the GUI.

The view may be provided in the GUI based on a determination that the GUI comprises a request for sensitive information. For example, the user device 102 may determine that the GUI contains a sensitive information entry field, such as, for example, based on an indication in a request sent by the server 110. The portion of the GUI may remain modified while the user 104 inputs the requested sensitive information into the entry field. The portion of the GUI may be modified in response to detecting selection of, or interaction with, the sensitive information entry field in the GUI. For example, the portion of the GUI may be modified in response to detecting that a “focus” of the GUI is on the sensitive information entry field. The GUI may remain unmodified when a non-sensitive information entry field in the GUI (e.g., a username entry field) is selected. In addition, the GUI may be reverted from its modified state (during entry into the sensitive information entry field) to its original, unmodified state when a non-sensitive information entry field is selected by the user 104.

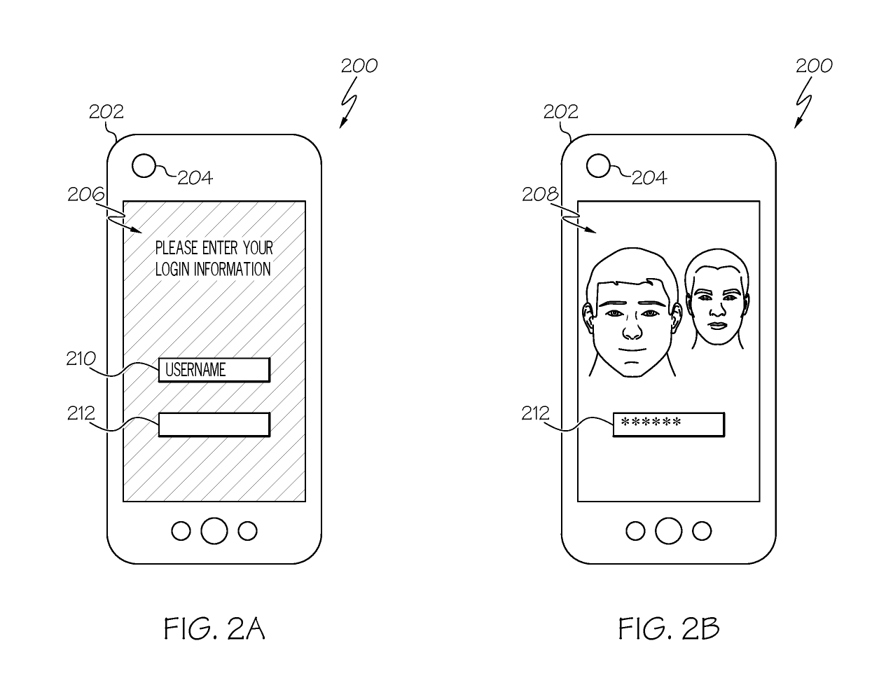

For example, suppose the user 104 is presented a GUI on the user device 102 to login to a page on the server 110. The login GUI may present an entry field for a username (or other identifier of the user 104), and an entry field for a password. The user 104 may select the username entry field and enter their username without any modification of the GUI occurring on the user device 102 (e.g., as shown in FIG. 2A). However, when the user 104 selects the password entry field (and the focus of the GUI is on the password entry field), the GUI may be modified to show a view of the surroundings. For example, a front-facing video camera of the user device 102 may be activated and video from the camera may be shown in an area near the password entry field (e.g., surrounding the password entry field) to show a view of the surroundings around the user device 102 (e.g., as shown in FIG. 2B), allowing the user 102 to determine whether the person 106 is “shoulder surfing”.

As another example, when the user 104 selects the password entry field, a portion of the GUI near the password entry field may be blacked out so the screen of the user device 102 acts as reflector to show a view of the surroundings. Blacking out the portions near or around the password entry field may effectively make the corresponding portions of the screen more reflective than if they were displaying content of the unmodified GUI. By using the reflective properties of the screen of the user device 102, users may be more aware of their physical surroundings. Moreover, blacking out portions of the GUI may allow for lower processor utilization, lower battery utilization, or both (e.g., by requiring fewer CPU or GPU cycles to display the content, or by requiring less energy from the battery to power the portions of the display that are blacked out).

FIG. 1B illustrates a simplified block diagram of the example user device 102 of FIG. 1A. In the example shown, the user device 102 includes a processor 112, memory 114, and an interface 116. The example processor 112 executes instructions, for example, to detect sensitive information entry fields in a GUI and modify the GUI upon detecting interaction with the sensitive information entry fields to present a view of physical surroundings. The instructions can include programs, codes, scripts, or other types of data stored in memory. Additionally, or alternatively, the instructions can be encoded as pre-programmed or re-programmable logic circuits, logic gates, or other types of hardware or firmware components. The processor 112 may be or include a general-purpose microprocessor, as a specialized co-processor or another type of data processing apparatus. In some cases, the processor 112 may be configured to execute or interpret software, scripts, programs, functions, executables, or other instructions stored in the memory 114. In some instances, the processor 112 includes multiple processors or data processing apparatuses.

The example memory 114 includes one or more computer-readable media. For example, the memory 114 may include a volatile memory device, a non-volatile memory device, or a combination thereof. The memory 114 can include one or more read-only memory devices, random-access memory devices, buffer memory devices, or a combination of these and other types of memory devices. The memory 114 may store instructions (e.g., programs, codes, scripts, or other types of executable instructions) that are executable by the processor 112.

The example interface 116 provides communication between the user device 102 and one or more other devices. For example, the interface 116 may include a network interface (e.g., a wireless interface or a wired interface) that allows communication between the user device 102 and the server 110 over the network 108. The interface 116 may include another type of interface, such as an interface for connecting other hardware components to the user device 102.

The example user device 102 runs (via the processor 112) an operating system 120 that manages execution of one or more applications 124 installed on the user device 102. The applications 124 may be any type of application executable on the user device 102, and may interface with servers, such as the server 110 to present information to a user of the user device 102 in a GUI displayed on the user device 102. The operating system 120 also manages execution of a sensitive entry field detection engine 122 that includes instructions for detecting sensitive information entry fields in GUIs for the applications 124 and modifying the GUI as described above based on detecting interaction with the sensitive information entry fields. The sensitive entry field detection engine 122 may be implemented in software, firmware, hardware, or a combination thereof.

In some embodiments, the operating system 120 may provide for an indication to be provided by the applications 124 as to whether certain data entry fields are for entry of sensitive information (e.g., passwords). The indication may be a field type code that is associated with an entry field in a GUI. For example, in the ANDROID operating system, text entry fields have an entry field type code like the one shown below by which the operating system determines whether a field is a password entry field:
android:inputType=“textPassword”.
   Similarly, in some instances, the operating system 120 can provide for another type of indication, such as, for example to state the field is sensitive and, as such, security measures like switching on a front-facing camera should be enacted. In the case of the ANDROID operating system example, the new option could be:
android:sensitive
   or similar. If the field type code android:inputType for an entry field in a GUI is set to be a password or other type of sensitive information, the sensitive entry field detection engine 122 may detect the request for sensitive information in the GUI and provide for security measures to be enacted when the sensitive information entry fields are interacted with by a user of the user device 102. For example, the sensitive entry field detection engine 122 may provide an instruction to enable a front-facing camera view in the GUI, or to black a portion of the GUI out (e.g., as described above).

In the example shown, the application 124A has an event listener 126. The event listener 126 may include instructions for detecting certain interactions, operations, and the like with the application 124A and performing certain actions based on the detections. For example, in some embodiments, the event listener 126 may detect an interaction with a sensitive data entry field of a GUI for the application 124A, and may, in response to the detection, indicate the detection to the sensitive entry field detection engine 122. The sensitive entry field detection engine 122 may then generate a command using an application programming interface (API) (e.g., make an API call) to the operating system 120 to switch on the camera 132 or black a portion of the GUI out. Generating the command may include accessing the API from the operating system API library 128. Once the sensitive data is submitted or another, non-sensitive information entry field is selected by the user, the event listener 126 may indicate the change in GUI focus to the sensitive entry field detection engine 122, and the sensitive entry field detection engine 122 may make another API call to the operating system 120 to switch off the camera 132 and revert the GUI to its previous view. The camera 132 may be any suitable camera coupled to the user device 102. In some instances, the camera 132 is a front-facing camera that shows a view in the direction of the screen of the user device 102 (e.g., toward a user of the user device 102).

In some embodiments, the application 124A (e.g., the event listener 126) may include instructions to make the API calls described above. For example, the application 124A may make an API call to switch on the camera 132 using an API from the operating system API library 128. In some embodiments, the instructions for making the API calls described above may be included in a software developer kit (SDK). For instances, the SDK may install an SDK API library 130, and the APIs used for API calls to the operating system 120 may be accessed from the SDK API library. In this manner, the need for each application 124 to develop its own process or code for implementing these techniques can be avoided. The SDK API library 130 can be accessed by any application 124 on the user device 102. The SDK may expose APIs in the SDK API library 130 that have logic for switching the camera 132 on or off, or for partially blacking out the screen of the user device 102. The SDK API library 130 may have either just camera switching or blacking out capabilities based on certain API parameters of the operating system 120.

FIGS. 2A-2B illustrate example GUIs 206, 208 of a user device 202 during entry of information into data entry fields 210, 212. In the example shown in FIG. 2A, the user device 202 presents the GUI 206, which prompts a user of the user device 102 to enter a username in the data entry field 210 and a password into the data entry field 212. The example data entry field 210 has been designated as a non-sensitive information entry field, while the example data entry field 212 has been designated as a sensitive information entry field (e.g., as described above).

In the example GUI 206 shown in FIG. 2A, the focus of the GUI 206 is on the data entry field 210 (as shown by the highlighting of the data entry field 210). The focus may be on the data entry field 210 based on a selection of, or other interaction with the data entry field 210 by a user of the user device 202. In the example shown in FIG. 2B, however, the focus of the GUI 208 has shifted to the data entry field 212. Because the data entry field 212 has been designated as a sensitive information entry field, the user device 202 has automatically modified the GUI 208 to show a view of physical surroundings around the user device 202. In the example shown, the user device 202 has turned on the front-facing camera 204 of the user device, and a view from the camera 204 is shown in the area surrounding the data entry field 212. As shown in the example GUI 208, the camera 204 may show another person looking over the user's shoulder at the GUI 208 (e.g., as shown in FIG. 1). The user may thus, be able to detect shoulder surfing that would otherwise be difficult to detect.

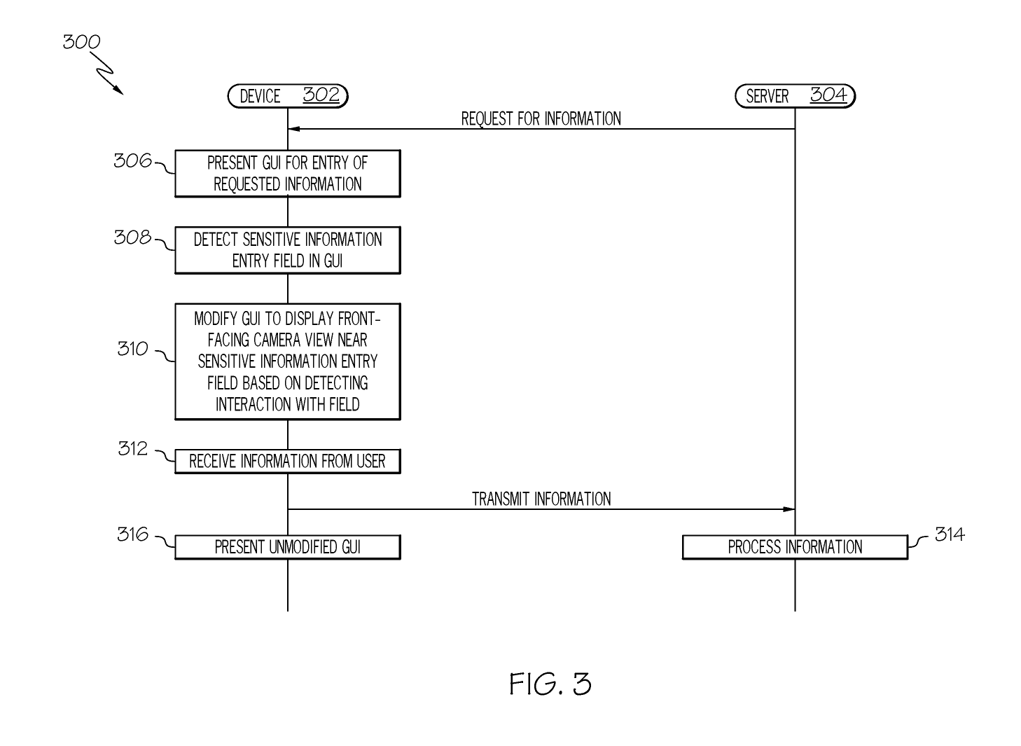

FIG. 3 illustrates an example signaling sequence 300 for securing entry of sensitive information on a user device. The example sequence 300 involves a user device 302 and a server 304. The user device 302 may be any type of device that can provide a GUI to a user for data entry (e.g., the user device 102 of FIGS. 1A-1B). The server 304 may be a web server that hosts information that a user of the user device 302 is attempting to access, such as the server 110 of FIG. 1A, or another type of server with information that the user may want to access. The sequence 300 may include additional or fewer operations than those shown in FIG. 3, and may involve additional devices or servers as appropriate.

In the example shown, the server 304 sends a request for information to the user device 302. The request may include a request for credentials (e.g., username and password) or another type of request for information that includes sensitive information. The user device 302 presents a GUI for entry of the requested information at 306, and detects a sensitive information entry field in the GUI at 308 (e.g., when the sensitive information entry field is interacted or the focus of the GUI is on the sensitive information entry field). The user device 302 modifies the GUI to display a front-facing camera view near the sensitive information entry field at 310, based on detecting interaction with the sensitive information entry field. The user device 302 then receives the requested information from a user of the device at 312, and after receiving the requested information, the information is transmitted to the server 304, which processes the information at 314 (e.g., authenticates credentials or other information entered at 312). The user device 302 then presents a previous, unmodified version of the GUI at 316. In some cases, the unmodified version of the GUI may be presented based on transmission of the information to the server 304, based on a focus of the GUI shifting away from the sensitive information entry field, or based on another factor.

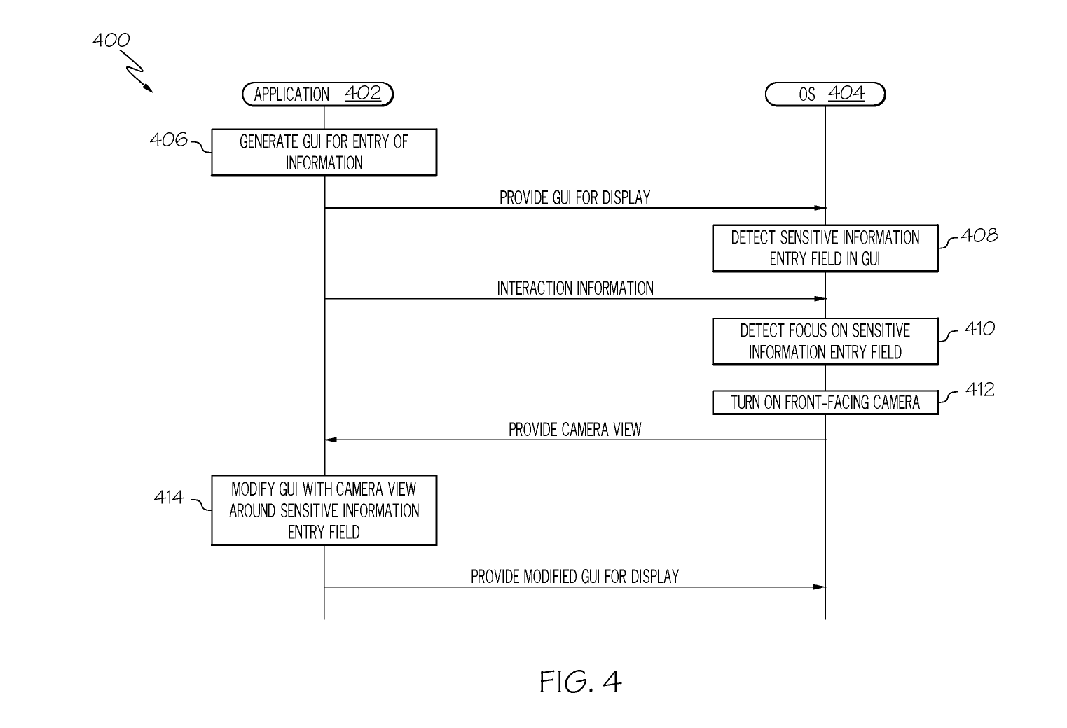

FIG. 4 illustrates another example signaling sequence 400 for securing entry of sensitive information on a user device. The example sequence 400 involves an application 402 of a user device and an operating system 404 of the user device. The application 402 may be any type of application that provides a GUI to a user for data entry (e.g., the GUIs 206, 208 of FIGS. 2A-2B), and the operating system 404 may be an operating system that controls execution of the application 402 and other applications on the user device. The sequence 400 may include additional or fewer operations than those shown in FIG. 4.

In the example shown, the application 402 generates a GUI for entry of certain information at 406, and provides the GUI to the operating system 404 for display. The GUI may be similar to the GUI 206 of FIG. 2A. The operating system 404 detects a sensitive information entry field in the GUI at 408, and receives indications of interaction with the GUI from the application 402. The operating system 404 detects interaction with the sensitive information entry field of the GUI at 410 based on the interaction information provided by the application 402 (e.g., detects focus of the GUI being on the sensitive information entry field), and turns on a front-facing camera of the user device in response at 412. The operating system 404 provides a view from the front-facing camera to the application 402, and the application 402 modifies the GUI to display the camera view around the sensitive information entry field at 414 and provides the modified GUI to the operating system 404 for display. The modified GUI may be similar to the GUI 208 of FIG. 2B.

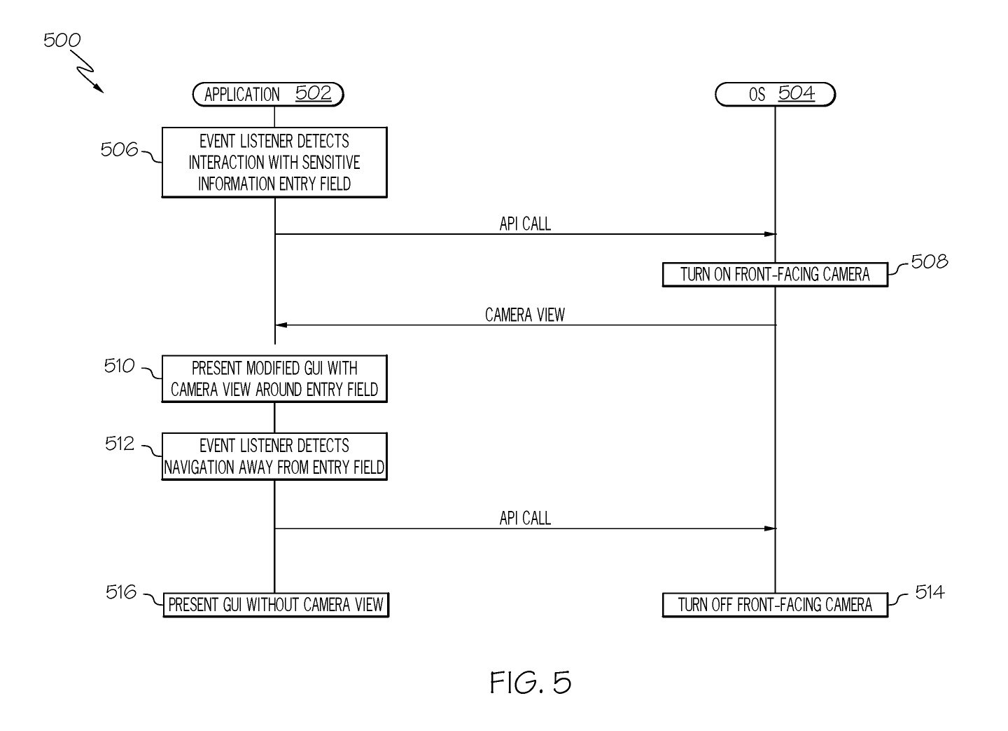

FIG. 5 illustrates another example signaling sequence 500 for securing entry of sensitive information on a user device. The example sequence 500 involves an application 502 of a user device and an operating system 504 of the user device. The application 502 may be any type of application that provides a GUI to a user for data entry (e.g., the GUIs 206, 208 of FIGS. 2A-2B), and the operating system 504 may be an operating system that controls execution of the application 502 and other applications on the user device. The sequence 500 may include additional or fewer operations than those shown in FIG. 5.

In the example shown, an event listener of the application 502 detects interaction with a sensitive information entry field in a GUI, and the application 502 makes an API call to the operating system 504 to turn on a front-facing camera of the device. The operating system 504 then turns on the camera at 508 and provides a view of the camera to the application 502. The application 502 then presents a modified version of the GUI with the camera view around the sensitive entry field at 510 (e.g., as shown in FIG. 2B). The event listener then detects navigation away from the sensitive information entry field at 512 and makes another API call to the operating system 504 to turn off the front-facing camera in response. Navigation away from the sensitive information entry field may include selecting another, non-sensitive information entry field of the GUI, presenting a new GUI (e.g., in response to transmitting the sensitive information to a server), or navigating away from the application 502 on the user device. The operating system 504 turns off the camera at 514, and the application 502 presents the GUI without the camera view at 516 (e.g., reverting to a previous version of the GUI).

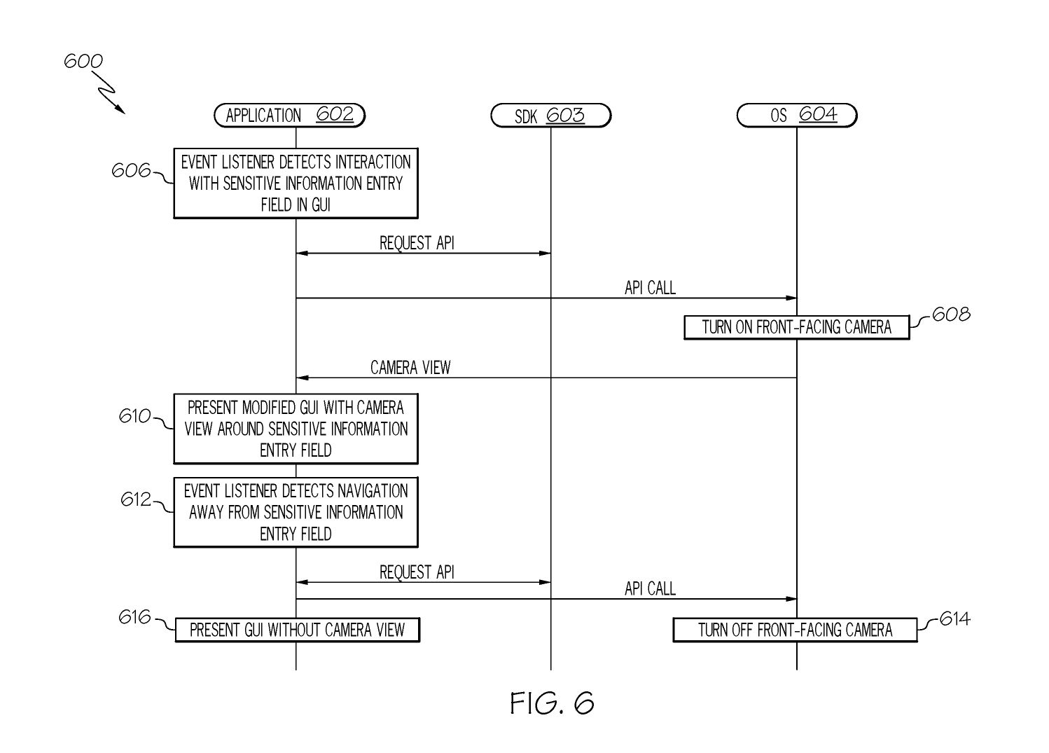

FIG. 6 illustrates another example signaling sequence for securing entry of sensitive information on a user device. The example sequence 600 involves an application 602 of a user device, an SDK 603 installed on the user device, and an operating system 604 of the user device. The application 602 may be any type of application that provides a GUI to a user for data entry (e.g., the GUIs 206, 208 of FIGS. 2A-2B), and the operating system 604 may be an operating system that controls execution of the application 602 and other applications on the user device. The SDK may be a software module or other type of computer code installed on the device that provides APIs (e.g., those described above with respect to the SDK library 130 of FIG. 1B) for certain commands to be issued to the operating system 604. The sequence 600 may include additional or fewer operations than those shown in FIG. 6.

In the example shown, an event listener of the application 602 detects an interaction with a sensitive information entry field of a GUI at 606 (e.g., detects a selection of the sensitive information entry field by a user, or a focus of the GUI on the sensitive information entry field). In response, the application 602 requests an API from the SDK 603 for turning on a front-facing camera of the user device. The application 602 generates a command using an API provided by the SDK 603, and accordingly makes an API call to the operating system 604. The operating system 604 then turns on the front-facing camera of the user device at 608 in response to the API call, and provides a view of the camera to the application 602. The application 602 presents a modified GUI with the camera view around the sensitive information entry field in the GUI at 610 (e.g., as shown in FIG. 2B). The event listener then detects navigation away from the sensitive information entry field at 612, and requests another API from the SDK 603 for turning off the front-facing camera of the device. The application 602 generates a command using the API provided by the SDK 603, and accordingly makes an API call to the operating system 604, which turns off the front-facing camera of the device at 614. The application 602 then presents the GUI without the camera view at 616 (e.g., reverts to a previous version of the GUI).

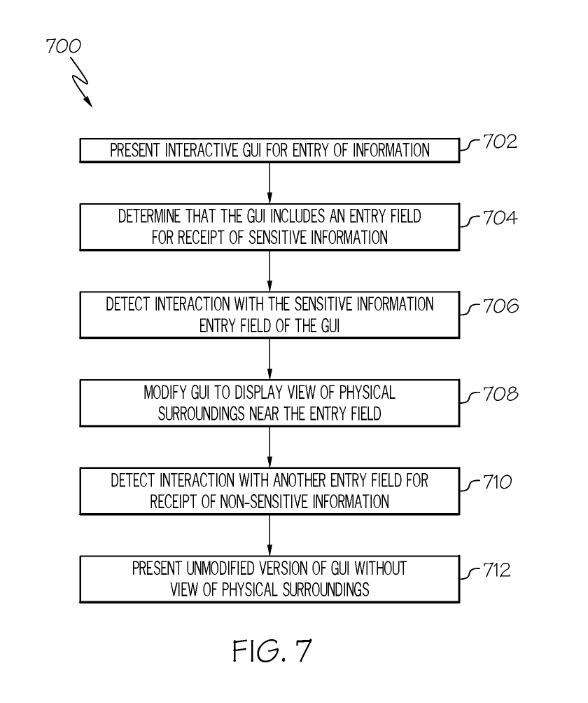

FIG. 7 is a flowchart illustrating an example process 700 for securing entry of sensitive information on a user device. Operations in the example process 700 may be performed by components of a user device (e.g., the user device 102 of FIGS. 1A-1B). The example process 700 may include additional or different operations, and the operations may be performed in the order shown or in another order. In some cases, one or more of the operations shown in FIG. 7 are implemented as processes that include multiple operations, sub-processes, or other types of routines. In some cases, operations can be combined, performed in another order, performed in parallel, iterated, or otherwise repeated or performed another manner.

At 702, an interactive GUI is presented to a user for entry of certain information. The GUI may include data entry fields for receipt of the information. In some cases, the GUI includes data entry fields for receipt of sensitive information (e.g., a password) and non-sensitive information (e.g., a username). The GUI may be presented on the display of a personal computing device, such as a desktop computer, laptop computer, smartphone, tablet, smart watch, or another type of personal computing device. The personal computing device may be implemented similar to the user device 102 of FIGS. 1A-1B.

At 704, it is determined that the GUI includes an entry field for receipt of sensitive information (a sensitive information entry field). The sensitive information entry field may be detected by an operating system of the personal computing device, the application providing the GUI for display, an event listener of the application, a sensitive entry field detection engine of the user device (e.g., the sensitive entry field detection engine 122 of FIG. 1B), or a combination thereof. In some embodiments, for example, the sensitive information entry field is detected based on a field type code associated with the sensitive information entry field. The field type code may be formatted similar to the ANDROID field type code android:inputType.

At 706, an interaction with the sensitive information entry field of the GUI is detected. The interaction may be detected based on detecting that the entry field has been selected by a user of the device for entry of the sensitive information, detecting that a focus of the GUI is on the sensitive information entry field, or in another manner. In some cases, the operating system of the device may detect the field (e.g., based on a field type code) and automatically modify the GUI when an interaction with the field is detected. In some cases, an event listener of an application providing the GUI may detect the interaction with the sensitive information entry field, and may accordingly initiate a request by the application for an operating system function to modify the GUI. The request may be based on an API of the operating system or an SDK installed on the device.

At 708, the GUI is modified to display a view of physical surroundings around the device based on the detection at 706. In particular, a portion of the GUI is modified to display the view of the physical surroundings near the sensitive information entry field in the GUI. For example, in some instances, an area of the GUI surrounding the sensitive information entry field may be modified (e.g., as shown in FIG. 2B). In some embodiments, the portion of the GUI around the sensitive information entry field is modified to display a view from a camera of the personal computing device in the portion of the GUI near the entry field. In some embodiments, the portion of the GUI near the sensitive information entry field is modified to display a black screen in the portion of the GUI near the entry field. The black screen may cause the display to function as a mirror at the portion of the GUI, such as, through reflections on the screen of the device.

At 710, an interaction with another field of the GUI for receipt of non-sensitive information is detected. The interaction may be detected based on detecting that the non-sensitive information entry field has been selected by a user of the device for entry of the non-sensitive information, detecting that a focus of the GUI is on the non-sensitive information entry field, detecting that the sensitive information entry field is no longer selected by the user for entry of the sensitive information, or in another manner.

At 712, an unmodified version of the GUI is presented based on the detection at 710. The unmodified version of the GUI does not include the view of physical surroundings (e.g., as shown in FIG. 2A). Presenting the unmodified version of the GUI may include automatically reverting the portion of the GUI that was modified to a previous version of the GUI.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
presenting an interactive graphical user interface (GUI) on a display of a personal computing device;
determining that the GUI comprises an entry field for receipt of sensitive information from a user of the personal computing device;
detecting an interaction with the entry field; and
automatically modifying at least a portion of the GUI near the entry field to provide a view of physical surroundings near the personal computing device, wherein the portion of the GUI remains modified while the user inputs the sensitive information to the entry field, and the portion of the GUI is modified in response to detecting the interaction and based on determining that the GUI comprises a request for entry of sensitive information.

2. The method of claim 1, wherein the portion of the GUI surrounds the entry field.

3. The method of claim 1, wherein detecting the interaction comprises detecting that the entry field has been selected by the user for entry of the sensitive information.

4. The method of claim 3, further comprising:
detecting that the entry field is no longer selected by the user for entry of the sensitive information; and
automatically reverting the portion of the GUI near the entry field to a previous version of the GUI based on detecting that the entry field is no longer selected.

5. The method of claim 1, wherein modifying the portion of the GUI near the entry field comprises displaying a view from a camera of the personal computing device in the portion of the GUI near the entry field.

6. The method of claim 1, wherein modifying the portion of the GUI near the entry field comprises displaying a black screen in the portion of the GUI near the entry field, wherein the black screen causes the display to function as a mirror at the portion of the GUI.

7. The method of claim 1, wherein the entry field is for receipt of password information.

8. The method of claim 1, wherein determining that the GUI comprises an entry field for receipt of sensitive information comprises detecting, by an operating system of the personal computing device, a field type code associated with the entry field.

9. The method of claim 1, wherein the interaction with the entry field is detected by an event listener of an application of the personal computing device, and the method further comprises requesting, by the application, an operating system function to modify the GUI.

10. The method of claim 9, wherein requesting the operating system function comprises generating a request using an application programming interface (API).

11. The method of claim 10, wherein the API is an API of a software development kit (SDK) installed on the personal computing device.

12. A non-transitory computer readable medium having program instructions stored therein, wherein the program instructions are executable by a computer system to perform operations comprising:
generating a graphical user interface (GUI) comprising entry fields for receipt of information;
detecting that a particular entry field of the GUI has been selected for data entry;
determining that the particular entry field is indicated to receive sensitive information; and
generating a modified version of the GUI, the modified version of the GUI comprising the particular entry field and a view from a camera near the entry field, wherein the GUI remains modified while the particular entry field is selected.

13. The non-transitory computer readable medium of claim 12, wherein determining that the particular entry field is indicated to receive sensitive information comprises detecting a field type code associated with the particular entry field.

14. The non-transitory computer readable medium of claim 12, wherein generating the modified version of the GUI comprises generating a command requesting the camera view using an application programming interface (API).

15. The non-transitory computer readable medium of claim 14, wherein generating the command comprises using an API of a software development kit (SDK).

16. A system comprising:
a data processing apparatus;
a memory;
a display; and
a sensitive entry field detection engine, executable by the data processing apparatus to:
generate a graphical user interface (GUI) on the display, the GUI comprising entry fields for receipt of information;
detect that a particular entry field of the GUI has been selected for data entry;
determine that the particular entry field is indicated to receive sensitive information; and
generate a modified version of the GUI that provides a view of physical surroundings near the display, wherein the GUI remains modified while the particular entry field is selected.

17. The system of claim 16, wherein the sensitive entry field detection engine is further executable by the data processing apparatus to determine that the particular entry field is indicated to receive sensitive information by detecting a field type code associated with the particular entry field.

18. The system of claim 16, wherein the sensitive entry field detection engine is further executable by the data processing apparatus to generate the modified version of the GUI by generating a command using an application programming interface (API).

19. The system of claim 18, wherein the sensitive entry field detection engine is further executable by the data processing apparatus to generate the command based on an API of a software development kit (SDK).

20. The system of claim 16, further comprising a camera, wherein the sensitive entry field detection engine is further executable by the data processing apparatus to generate the modified version of the GUI by displaying a view from the camera in a portion of the GUI.
